(19) United States
(12) Patent Application Publication
(10) Pub. No.: US 2014/0354901 A1
(43) Pub. Date: Dec. 4, 2014

(54) TOUCH PANEL

(71) Applicants: NANCHANG O-FILM TECH CO., LTD., NANCHANG CITY (CN); SHENZHEN O-FILM TECH CO., LTD., SHENZHEN CITY (CN); SUZHOU O-FILM TECH CO., LTD.,, SUZHOU CITY (CN)

(72) Inventors: Yunhua Zhao, Shenzhen City (CN); Yulong Gao, Shenzhen City (CN); Yunliang Yang, Shenzhen City (CN); Shaou Zhao, Shenzhen City (CN)

(73) Assignees: NANCHANG O-FILM TECH CO., LTD., NANCHANG CITY (CN); SHENZHEN O-FILM TECH CO., LTD., SHENZHEN CITY (CN); SUZHOU O-FILM TECH CO., LTD., SUZHOU CITY (CN)

(21) Appl. No.: 13/975,274

(22) Filed: Aug. 23, 2013

Related U.S. Application Data
(63) Continuation of application No. PCT/CN2013/079199, filed on Jul. 11, 2013.

(30) Foreign Application Priority Data
May 30, 2013 (CN) 201310209930.3

(51) Int. Cl. G06F 1/16

(52) U.S. Cl. CPC G06F 1/1692
USPC 349/12

(57) ABSTRACT

A touch panel includes: a transparent cover lens, a transparent conductive film and a display apparatus which are successively stacked. The transparent conductive film includes a transparent substrate including a body and a flexible board, where the width of the flexible board is smaller than the width of the body. The body includes a sensing area, a border area located at the edge of the sensing area, a conduction line disposed on a side of the flexible transparent substrate; a first conductive layer disposed on a side of the sensing area, where the first conductive layer includes first conductive wires intercrossing each other, and a first electrode trace disposed on a side of the border area, via which the first conductive layer and the conduction line are electrically connected. The production efficiency of the transparent conductive film of the above touch panel of the present invention is improved.

### CROSS REFERENCE TO RELATED APPLICATIONS

This application is a continuation of International Patent Application NO. PCT/CN2013/079199, filed on Jul. 11, 2013, which claims priority to Chinese Patent Application No. 201310209930.3, filed on May 30, 2013, both of which are hereby incorporated by reference in their entireties.

### TECHNICAL FIELD

The present invention relates to the field of touch screen and, in particular, to a touch panel.

### BACKGROUND

A capacitive touch screen utilizes current sensing of a person's body to work. When a metal layer is touched by a finger, a coupling capacitance is formed between the user and a surface of the capacitive touch screen, and a tiny current is absorbed by the finger from the contact point. This current flows out from electrodes disposed on four corners of the capacitive touch screen, respectively, and strength of the currents flowing out from the four electrodes is in direct proportion to the distance between the finger and the four corners. Therefore, the position of the contact point is obtained by a controller through precise calculation of four proportions of current.

A transparent conductive film is a thin film with good conductivity and high optical transparency within a visible wavelength band. Currently, transparent conductive films have been widely used in the fields of flat panel display, photovoltaic device, touch panel, electromagnetic shielding, and so forth. Transparent conductive films have an extremely broad market potential.

A flexible circuit board, which is made by using polyimide or polyester film as a substrate, is a highly reliable printed circuit board with extremely flexibility. The flexible circuit board, abbreviated as soft board or FPC (Flexible Printed Circuit), is characterized by high wiring density, light weight and thin thickness. The transparent conductive film is connected to an external circuit via the FPC, thereby, the position signal sensed by the transparent conductive film is transferred to a processor and identified, so as to determine the touch position.

Conventionally, when connecting a transparent conductive film of a touch panel to an external circuit board via FPC, the FPC is applied to a lead area of transparent conductive film firstly, and then the FPC is connected to a printed circuit board (PCB), which leads to low production efficiency.

### SUMMARY

Based on this, it is necessary to provide a touch panel which can be produced with high efficiency.

A touch panel, includes a transparent cover lens, a transparent conductive film and a display apparatus which are successively stacked; where the transparent conductive film includes:

a transparent substrate, wherein the transparent substrate includes a body and a flexible board which is formed by extending from one end of the body, a width of the flexible board is smaller than a width of the body, the body includes a sensing area and a border area which is located at an edge of the sensing area;

a conduction line, disposed on a side of the flexible transparent substrate;

a first conductive layer, disposed on a side of the sensing area, where the first conductive layer includes first conductive wires intercrossing each other; and

a first electrode trace, disposed on a side of the border area, the first conductive layer and the conduction line are electrically connected via the first electrode trace.

In an embodiment of the present invention, on a surface of the sensing area, a first conductive groove is disposed, and the first conductive layer is accommodated in the first conductive groove;

the first electrode trace is embedded in a surface of the border area, or is directly disposed on the surface of the border area.

In an embodiment of the present invention, the transparent conductive film further includes a second conductive layer and a second electrode trace, and a second conductive groove is disposed on the surface of the sensing area corresponding to the first conductive layer, where the second conductive layer is accommodated in the second conductive groove; and

the second electrode trace is embedded in the surface of the border area, or is directly disposed on the surface of the border area, and the second conductive layer and the conduction line are electrically connected via the second electrode trace.

In an embodiment of the present invention, the transparent conductive film further includes a matrix layer, a second conductive layer and a second electrode trace, where the matrix layer is disposed on a surface of the transparent substrate away from the first conductive layer;

on a surface, which is away from the transparent substrate, of the matrix layer corresponding to the sensing area, a second conductive groove is disposed, and the second conductive layer is accommodated in the second conductive groove;

the second electrode trace is embedded in a surface of the matrix layer corresponding to the sensing area, or is directly disposed on the surface of matrix layer corresponding to the sensing area, and the second conductive layer and the conduction line are electrically connected via the second electrode trace.

In an embodiment of the present invention, the transparent conductive film further includes a matrix layer, a second conductive layer and a second electrode trace, where the matrix layer is disposed on a surface of the first conductive layer; on a surface, which is away from the transparent substrate, of the matrix layer corresponding to the sensing area, a second conductive groove is disposed, and the second conductive layer is accommodated in the second conductive grove;

the second leading electrode is embedded in a surface of the matrix layer corresponding to the border area, or is directly disposed on the surface of the matrix layer corresponding to the border area, and the second conductive layer and the conduction line are electrically connected via the second electrode trace.

In an embodiment of the present invention, the transparent conductive film further includes a first matrix layer disposed on the transparent substrate, and a first conductive groove is disposed on a surface of the first matrix layer away from the transparent substrate, where the first conductive layer is accommodated in the first conductive notch;

the first electrode trace is embedded in a surface of the first matrix layer corresponding to the border area, or is directly disposed on the surface of the first matrix layer corresponding to the border area.

In an embodiment of the present invention, the transparent conductive film further includes a second matrix layer, a second conductive layer and a second electrode trace, where the first matrix layer, the transparent substrate and the second matrix layer are successively stacked; on a surface of the second matrix layer away from the transparent substrate, a second conductive groove is disposed, and the second conductive layer is accommodated in the second conductive groove;

the second electrode trace is embedded in a surface of the second matrix layer corresponding to the sensing area, or is directly disposed on the surface of the second matrix layer corresponding to the sensing area, and the second conductive layer and the conduction line are electrically connected via the second electrode trace.

In an embodiment of the present invention, the transparent conductive film further includes a second matrix layer, a second conductive layer and a second electrode trace, where, the second matrix layer is disposed on a surface of the first conductive layer, on a surface of the second matrix layer away from the first conductive layer, a second conductive groove is disposed, and the second conductive layer is accommodated in the second conductive groove;

the second electrode is embedded in a surface of the second matrix layer corresponding to the sensing area, or is directly disposed on the surface of the second matrix layer corresponding to the sensing area, and the second conductive layer and the conduction line are electrically connected via the second electrode trace.

In an embodiment of the present invention, a bottom of the first conductive groove is of a non-planar structure, and a bottom of the second conductive groove is of a non-planar structures.

In an embodiment of the present invention, a width of the first conductive groove is 0.2 μm˜5 μm, a height of the first conductive groove is 2 μm˜6 μm, and a height to width ratio is greater than 1;

a width of the second conductive groove is 0.2 μm˜5 μm, a height of the second conductive groove is 2 μm˜6 μm, and a height to width ratio is greater than 1.

In an embodiment of the present invention, a material of the first matrix layer is UV adhesive, embossed plastic or polycarbonate;

a material of the second matrix layer is UV adhesive, embossed plastic or polycarbonate.

In an embodiment of the present invention, the first electrode trace is grid-shaped or strip-shaped, the grid-shaped first electrode trace comprises first conductive leads intercrossing each other, the strip-shaped first electrode trace has a minimal width of 10 μm˜200 μm and a height of 5 μm˜20 μm; the second electrode trace is grid-shaped or strip-shaped, the grid-shaped second electrode trace comprises second conductive leads intercrossing each other, the strip-shaped second electrode trace has a minimal width of 10 μm˜200 μm and a height of 5 μm˜20 μm.

In an embodiment of the present invention, the conduction line is grid-shaped or strip-shaped, the grid-shaped conduction line is formed by intercrossing conduction wires.

In an embodiment of the present invention, the transparent conductive film further includes a transparent protection layer, where the transparent protection layer covers at least a part of the transparent substrate, the first conductive layer, the second conductive layer, the first electrode trace, the second electrode trace and the conduction line.

In an embodiment of the present invention, a visible light transmittance of the transparent conductive film is not less than 86%.

According to embodiments of the present invention, the transparent substrate of the transparent conductive film of the touch panel includes a body and a flexible board; and the first conductive layer, the second conductive layer and conduction line are disposed on the same transparent substrate so as to form the conductive film and the flexible circuit board. Therefore, comparing with the conventional method that needs to adhere a conductive film and a flexible circuit board by an adhering process, the production efficiency of the transparent conductive film according to embodiments of the present invention can be improved since an adhering process is not needed.

### BRIEF DESCRIPTION OF DRAWINGS

FIG. 1 is a schematic structure diagram of a touch panel according to an embodiment of the present invention;

FIG. 2 is a schematic structure diagram of an edge of a transparent conductive film according to an embodiment of the edge of the transparent conductive film;

FIG. 3 is a schematic structure diagram of a groove bottom according to an embodiment of the present invention;

FIG. 4 is a schematic structure diagram of conductive grids according to an embodiment of the present invention;

FIG. 5 is a schematic structure diagram of conductive grids according to another embodiment of the present invention;

FIG. 6 is a schematic diagram of a cross-sectional structure of a transparent conductive film according to another embodiment of the present invention;

FIG. 7 is a schematic diagram of a cross-sectional structure of a transparent conductive film according to another embodiment of the present invention;

FIG. 8 is a schematic diagram of a cross-sectional structure of a transparent conductive film according to another embodiment of the present invention;

FIG. 9 is a schematic diagram of a cross-sectional structure of a transparent conductive film according to another embodiment of the present invention;

FIG. 10 is a schematic diagram of a cross-sectional structure of a transparent conductive film according to another embodiment of the present invention;

FIG. 11 is a schematic diagram of a cross-sectional structure of a transparent conductive film according to another embodiment of the present invention;

FIG. 12 is a schematic diagram of a cross-sectional structure of a transparent conductive film according to another embodiment of the present invention;

FIG. 13 is a schematic diagram of a cross-sectional structure of a transparent conductive film according to another embodiment of the present invention;

FIG. 14 is a schematic diagram of a cross-sectional structure of a transparent conductive film according to another embodiment of the present invention;

FIG. 15 is a schematic diagram of a cross-sectional structure of a transparent conductive film according to another embodiment of the present invention;

FIG. 16 is a schematic diagram of a cross-sectional structure of a transparent conductive film according to another embodiment of the present invention;

FIG. 17 is a schematic diagram of a partial cross-sectional structure of a transparent conductive film according to another embodiment of the present invention.

### DESCRIPTION OF EMBODIMENTS

To make the objectives, features and advantages of embodiments of the present invention clearer, the following comprehensively describes the technical solutions in embodiments of the present invention with reference to the accompanying drawings. In the following, details of embodiments are described for more comprehensive understanding of the present invention. Nevertheless, the present invention can be implemented in many ways other than those embodiments described therein. Persons skilled in the art can make similar improvements without departing from the principle of the present invention, therefore, the present invention is not limited to the following disclosed embodiments.

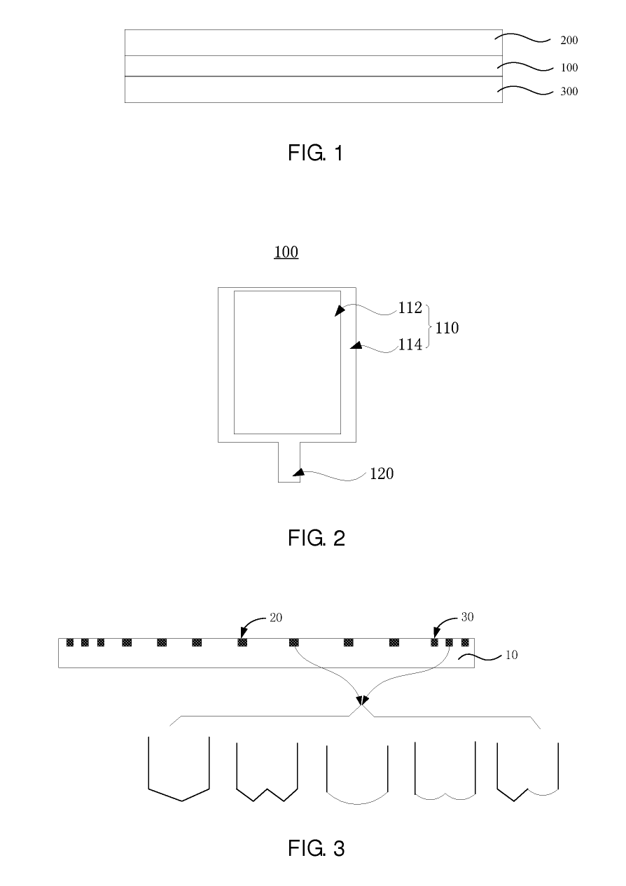

As shown in FIG. 1, a touch panel according to an embodiment includes a transparent cover lens 200, a transparent conductive film 100 and a display apparatus 300, which are successively stacked.

The transparent cover lens and the display apparatus can be the same as existing products, and are not discussed herein.

The following will focus on describing the transparent conductive film 100.

With reference to FIG. 1 and FIG. 2, a transparent conductive film 100 according to an embodiment of the present invention includes a transparent substrate 10, a first conductive layer 20, first electrode traces 30 and a conduction line.

The material of the transparent substrate 10 can be polyethylene terephthalate (PET) or thermoplastic material. The thermoplastic material can be polycarbonate (PC) or polymethylmethacrylate (PMMA).

The transparent substrate 10 includes a body 110 and a flexible board 120 which is formed by extending from one end of the body 110. The width of flexible board 120 is smaller than that of the body 110. The body 110 includes a sensing area 112 and a border area 114 which is located at the edge of the sensing area.

A first conductive groove is disposed on a surface of the sensing area 112. A first electrode groove is disposed on a surface of the border area 114. The first conductive groove and the first electrode groove are disposed on the same side.

A conduction groove is disposed on the flexible board 120. The conduction groove and the first conductive groove are disposed on the same side.

For convenience of description, the first conductive groove, the first electrode groove and the conduction groove are generally called the groove unless indicated otherwise. With reference to FIG. 3, the bottom of the groove is of a non-planar structure. The bottom of the groove may be “V”-shaped, “W”-shaped, curve or wave. The amplitude of the “V”-shaped, “W”-shaped, curve or wave bottom of the groove is 500 nm˜1 μm. As the bottom of the groove is set to be “V”-shaped, “W”-shaped, curve or wave, the shrinkage of the conductive material can be reduced in the drying and curing process after the conductive material is filled into the groove. Filing the conductive material into the groove and curing the conductive material to form first conductive wires, first conductive leads and conduction wires, can effectively protect the performance of the conductive material and prevent the breakage of the conductive material caused by shrinkage of the conductive material during the baking process. The width of the groove may be 0.2 μm˜5 μm, the height of the groove may be 2 μm˜6 μm, and the height to width ratio is greater than 1.

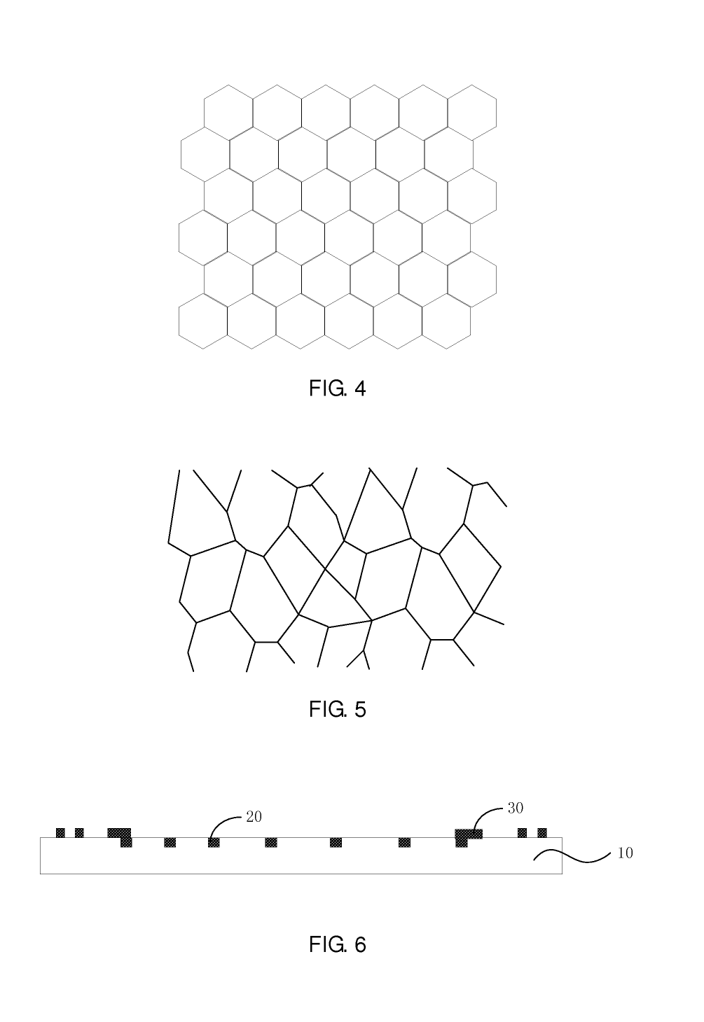

The first conductive layer 20 is accommodated in the first conductive groove. The first conductive layer 20 is grid-shaped. With reference to FIG. 4 and FIG. 5, the grids of the first conductive layer 20 can be regular grids with repeated pattern (FIG. 4) or random grids (FIG. 5). The first conductive layer 20 includes first conductive wires intercrossing each other. The first conductive layer 20 is formed by curing the conductive material filled into the first conductive groove. The material of the first conductive layer 20 can be conductive metal. The conductive metal may be silver or copper.

The first electrode traces 30 are accommodated in the first electrode groove. The first electrode traces 30 and the first conductive layer 20 are disposed on the same side. The first conductive layer 20 and the conduction line are electrically connected via the first electrode traces 30, so as to transfer touch signals detecting by the sensing area to the conduction line.

The first electrode traces 30 may be grid-shaped or strip-shaped. The grid-shaped first electrode traces 30 include intercrossing first conductive leads. Referring to FIG. 4 and FIG. 5, the grids of the first electrode traces 30 may be regular grids with repeated pattern (FIG. 4) or random grids (FIG. 5). The first electrode traces 30 are formed by curing the conductive material filled into the first conductive groove. The material of the first electrode traces 30 may be a conductive metal, and the conductive metal may be silver or copper.

For the strip-shaped first electrode traces 30, a minimal width may be 10 μm˜200 μm, and a height may be 5 μm˜20 μm.

The conduction line may be grid-shaped or strip-shaped. The grid-shaped conduction line includes conductions wires intercrossing each other. Referring to FIG. 4 and FIG. 5, the grids of the conduction line may be regular grids with repeated pattern (FIG. 4) or random grids (FIG. 5). The conduction line is formed by curing the conductive material filled into the conduction groove. The material of the conduction line may be a conductive metal, and the conductive metal may be silver or copper.

As shown in FIG. 6, the first electrode traces 30 may also be directly disposed on the surface of the border area, and the first electrode traces 30 and the first conductive layer are at the same side. In this case, the first electrode traces 30 may be formed by screen printing, lithography or ink-jet printing.

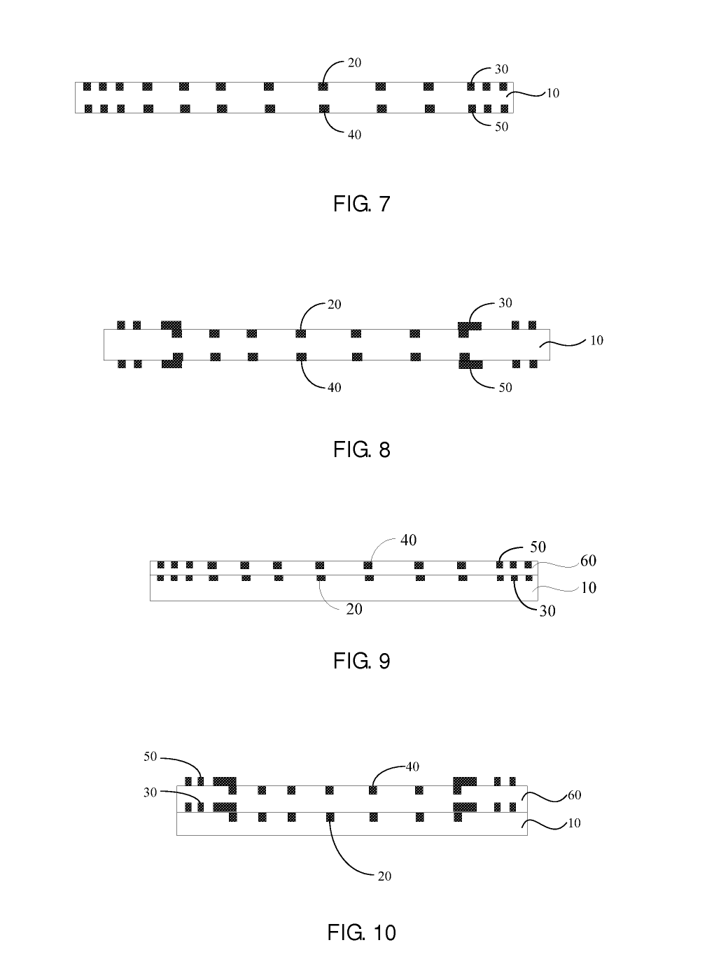

As shown in FIG. 7, a transparent conductive film according to another embodiment, includes the structures of the transparent conductive film shown in FIG. 1, and further includes a second conductive layer 40 and second electrode traces 50. The structures of the transparent conductive film shown in FIG. 8 which are similar with the relevant structures of the transparent conductive film shown in FIG. 1, are not further discussed here.

The second conductive layer 40 is grid-shaped. On the surface of the sensing area opposite to the first conductive layer 20, a second conductive groove is disposed, and the second conductive layer 40 is accommodated in the second conductive groove.

On the surface of the border area, a second electrode groove is disposed, and the second electrode traces 50 are accommodated in the second electrode groove. The second electrode traces 50 and the second conductive layer 40 are on the same side, and the second conductive layer 40 and the conduction line are electrically connected via the second electrode traces 50.

It could be understood that, as shown in FIG. 8, the first electrode traces 30 may be directly disposed on the surface of the border area, and the first electrode traces 30 and the first conductive layer 20 are on the same side. The second electrode traces 50 may be directly disposed on the other surface of the border area, and the second electrode traces 50 and the second conductive layer 40 are on the same side.

As shown in FIG. 9, a transparent conductive film according to another embodiment of the present invention includes the structures of the transparent conductive film shown in FIG. 1, and further includes a matrix layer 60, a second conductive layer 40 and second electrode traces 50. The structures of the transparent conductive film shown in FIG. 9 which are similar with the relevant structures of the transparent conductive film shown in FIG. 1, are not further discussed here.

The matrix layer 60 is disposed on the surface of the first conductive layer 20, and on the surface, which is away from the transparent substrate 10, of the matrix layer 60 corresponding to the sensing area, a second conductive groove is disposed, the second conductive layer 40 is accommodated in the second conductive groove.

On the surface of the matrix layer 60 corresponding to the border area, a second electrode groove is disposed, and the second electrode traces 50 are accommodated in the second electrode groove. The second electrode traces 50 and the second conductive layer 40 are on the same side, and the second conductive layer 40 and the conduction line are electrically connected via the second electrode traces 50.

It could be understood that, as shown in FIG. 10, the first electrode traces 30 may also be directly disposed on the surface of the border area, and the first electrode traces 30 and the first conductive layer 20 are disposed on the same side. The second electrode traces 50 may also be directly disposed on the surface of the matrix layer 60 corresponding to the border area, and the second electrode traces 50 and the second conductive layer 40 are disposed on the same side.

For convenience of description, the second conductive grooves and the second electrode grooves the transparent conductive films according to embodiments of the present invention shown in FIG. 7-FIG. 10, are all called groove. Referring to FIG. 3, the bottom of the groove may be of a non-planar structure. The bottom of the groove may be “V”-shaped, “W”-shaped, curved or wavy. The amplitude of the “V”-shaped, “W”-shaped, curved or wavy bottom of the groove is 500 nm˜1 μm. As the bottom of the groove is set to be “V”-shaped, “W”-shaped, curved or wavy, the shrinkage of the conductive material can be reduced in the drying and curing process after the conductive material is filled into the groove. Filing the conductive material into the second conductive groove and the second electrode groove and curing the conductive material to form the second conductive wires and the second electrode traces, can effectively protect the performance of the conductive material and prevent the breakage of the conductive material caused by shrinkage of the conductive material during the baking process. The width of the groove may be 0.2 μm˜5 μm, the height of the groove may be 2 μm˜6 μm, and the height to width ratio is greater than 1.

There is at least one flexible board (not showed in the figures) in the transparent conductive films according to embodiments of the present invention shown in FIG. 7-FIG. 10. When one flexible board is provided, a conduction groove is disposed on the flexible board, and the first electrode traces 30 and the second electrode traces 50 are electrically connected via the conduction groove. When two flexible boards 120 are provided, a conduction groove is disposed on the two flexible boards, respectively. The first electrode traces 30 and the second electrode traces 50 are electrically connected via the two conduction grooves, respectively.

The grids of the second conductive layer 40 of the transparent conductive films according to embodiments of the present invention shown in FIG. 7-FIG. 10, may be regular grids with repeated pattern (FIG. 5) or random grids (FIG. 6). The second conductive layer 40 includes second conductive wires intercros sing each other. The second conductive layer 40 is formed by curing the conductive material filled into the second conductive groove. The material of the second conductive layer 40 may be a conductive metal, and the conductive metal may be silver or copper.

The second electrode traces 50 of the transparent conductive films according to embodiments of the present invention shown in FIG. 7-FIG. 10 may be grid-shaped or strip-shaped. The grid-shaped second electrode traces 50 include the second conductive leads intercrossing each other. Referring to FIG. 5 and FIG. 6, the grids of the second electrode traces 50 may be regular grids with repeated pattern (FIG. 5) or random grids (FIG. 6). The second electrode traces 50 is formed by curing the conductive material filled into the second electrode groove. The material of the second electrode traces 50 may be a conductive metal, and the conductive metal may be silver or copper. For the strip-shaped second electrode traces 50, of the minimal width may be 10 μm˜200 μm, and the height may be 5 μm˜20 μm;

The material of the matrix layer 60 of the transparent conductive films according to embodiments of the present invention shown in FIG. 9 and FIG. 10 may be UV adhesive, embossed plastic or polycarbonate.

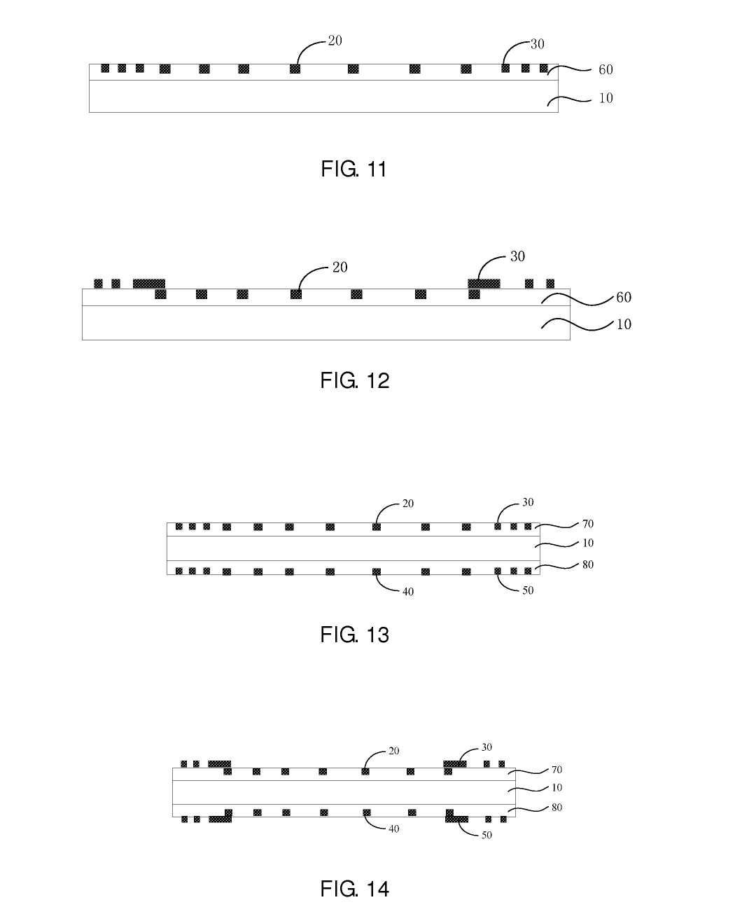

As shown in FIG. 11, a transparent conductive film according to another embodiment of the present invention includes a transparent substrate 10, a first matrix layer 70, a first conductive layer 20, first electrode traces 30 and a conduction line 40.

The material of the transparent substrate 10 may be polyethylene terephthalate (PET) or thermoplastic material. The thermoplastic material may be polycarbonate (PC) or polymethylmethacrylate (PMMA). Certainly, the material of the transparent substrate 10 may also be glass or other transparent materials.

The transparent substrate 10 includes a body 110 and a flexible board 120 formed by extending from one end of the body 110. The width of the flexible board 120 is smaller than that of the body 110. The body 110 includes a sensing area 112 and a border area 114 located at the edge of the sensing area.

The first matrix layer 70 is disposed on the surface of the transparent substrate 10. On the surface of the first matrix layer 70 away from the transparent basement 10, a first conductive groove is disposed, and the first conductive layer 20 is accommodated in the first conductive groove.

The material of the first matrix layer 70 may be UV adhesive, embossed plastic or polycarbonate.

A conduction groove is disposed on the flexible board 120. The conduction groove and the first conductive groove are disposed on the same side.

On the surface of the first matrix layer 70 corresponding to the border area, the first conductive groove is disposed. The first conductive groove and the first electrode groove are disposed on the same side. The first electrode traces 30 are accommodated in a conductive groove.

For convenience of description, the first conductive groove, the first electrode groove and the conduction groove are all called groove. Referring to FIG. 3, the bottom of the groove may be of a non-planar structure. The bottom of the groove may be “V”-shaped, “W”-shaped, curved or wavy. The amplitude of the “V”-shaped, “W”-shaped, curved or wavy bottom of the groove is 500 nm˜1 μm. As the bottom of the groove is set to be “V”-shaped, “W”-shaped, curved or wavy, the shrinkage of the conductive material can be reduced in the drying and curing process after the conductive material is filled into the groove. Filing the conductive material into the groove and curing the conductive material to form the first conductive wires, the first conductive leads and conduction wires, can effectively protect the performance of the conductive material and prevent the breakage of the conductive material caused by shrinkage of the conductive material during the baking process. The width of the groove may be 0.2 μm˜5 μm, the height of the groove may be 2 μm˜6 μm, and the height to width ratio is greater than 1.

The first conductive layer 20 is grid-shaped. Referring to FIG. 4 and FIG. 5, the grids of the first conductive layer 20 may be regular grids with repeated pattern (FIG. 4) or random grids (FIG. 5). The first conductive layer 20 includes first conductive wires intercrossing each other. The first conductive layer 20 is formed by curing the conductive material filled into the first conductive groove. The material of the first conductive layer 20 may be a conductive metal, and the conductive metal may be silver or copper.

The first electrode traces 30 and the first conductive layer 20 are on the same side. The first conductive layer 20 and the conduction line are electrically connected via the first electrode traces 30. The first conductive layer 20 and the conduction line are electrically connected via the first electrode traces 30, so as to transfer touch signals detected by the sensing area to the conduction line.

The first electrode traces 30 may be grid-shaped or strip-shaped. The grid-shaped first electrode traces 30 include first lead wires intercrossing each other. Referring to FIG. 4 and FIG. 5, the grids of the first electrode traces 30 may be regular grids with repeated pattern (FIG. 4) or random grids (FIG. 5). The first electrode traces 30 are formed by curing the conductive material filled into the first electrode groove. The material of the first electrode traces 30 may be a conductive metal, and the conductive metal may be silver or copper.

For the strip-shaped first electrode traces 30, a minimal width may be 10 μm˜200 μm, and a height may be 5 μm˜20 μm.

The conduction line 60 can be grid-shaped or strip-shaped.

The grid-shaped conduction line 60 includes conduction wires intercrossing each other. Referring to FIG. 4 and FIG. 5, the grids of the conduction line 60 may be regular grids with repeated pattern (FIG. 4) or random grids (FIG. 5). The conduction line 60 is formed by curing the conductive material filled into the conduction groove. The material of the conduction line 60 can be a conductive metal, and the conductive metal may be silver or copper.

As shown in FIG. 12, the first electrode traces 30 may be directly disposed on the surface of the first matrix layer 70 corresponding to the border area.

As shown in FIG. 13, a transparent conductive film according to another embodiment of the present invention includes the structures of the transparent conductive film shown in FIG. 1, and further includes a second matrix layer 80, a second conductive layer 40 and second electrode traces 50. The structures of the transparent conductive film shown in FIG. 13, which are similar with the relevant structures of the transparent conductive film shown in FIG. 11, are not further discussed here.

The first matrix layer 70, the transparent substrate 10 and the second matrix layer 80 are successively stacked. On the surface of the second matrix layer 80 away from the transparent substrate 10, a second conductive groove is disposed, and the second conductive layer 40 is accommodated in the second conductive groove.

On the surface of the second matrix layer 80 corresponding to the sensing area, a second electrode groove is disposed, and the second electrode traces 50 are accommodated in the second electrode groove. The second electrode traces 50 and the second conductive layer 40 are on disposed on the same side, and the second conductive layer 40 and the conduction line are electrically connected via the second electrode traces 50.

It could be understood that, as shown in FIG. 14, the first electrode traces 30 may also be directly disposed on the surface of the first matrix layer 70 corresponding to the sensing area, and the first electrode traces 30 and the first conductive layer 20 are disposed on the same side. The second electrode traces 50 may also be directly disposed on the surface of the second matrix layer 80 corresponding to the sensing area, and the second electrode traces 50 and the second conductive layer 40 are disposed on the same side.

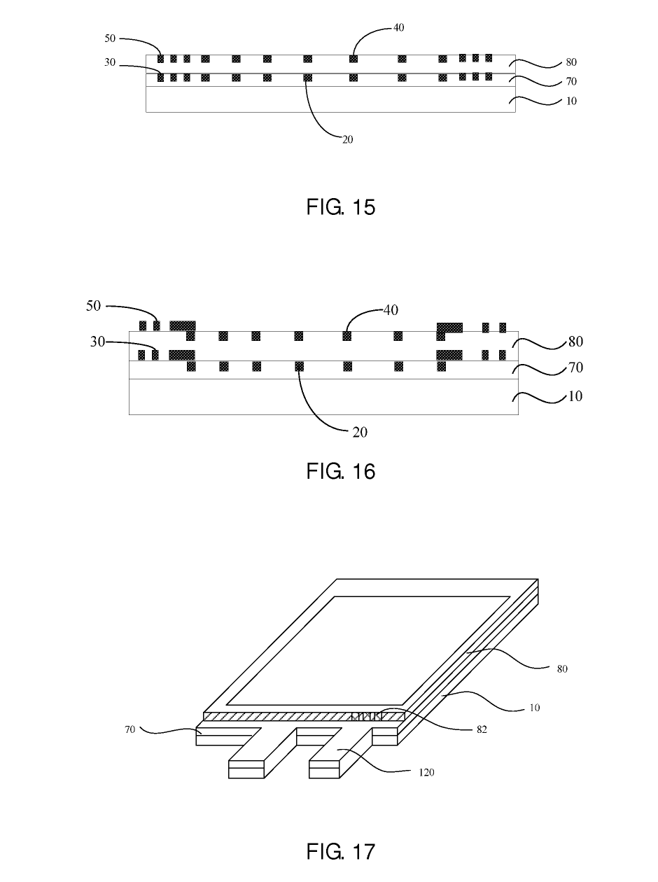

As shown in FIG. 15, a transparent conductive film according to another embodiment of the present invention includes the structures of the transparent conductive film shown in FIG. 1, and further includes a second matrix layer 80, a second conductive layer 40 and second electrode traces 50. The structures of the transparent conductive film shown in FIG. 15, which are similar with the relevant structures of the transparent conductive film shown in FIG. 11, are not further discussed here.

The second matrix layer 80 is disposed on the surface of the first conductive layer 20. On the surface of the second matrix layer 80 away from the first conductive layer 20, a second conductive groove is disposed, and the second conductive layer 40 is accommodated in the second conduction groove.

On the surface of the second matrix layer 80 corresponding to the sensing area, a second electrode groove is disposed, and the second electrode traces 50 are accommodated in the second electrode groove. The second electrode traces 50 and the second conductive layer 40 are disposed on the same side, and the second conductive layer 40 and the conduction line are electrically connected via the second electrode traces 50.

Referring to FIG. 17, a hole 82 is disposed on the second matrix layer 80, the second electrode traces 50 passes through the hole 82 and arrives at the first conductive layer 20 and, then, is electrically connected to the conduction line. The second electrode traces 50 and the first conductive layer 20 are insulated from each other. Certainly, in other embodiments, the second electrode traces 50 may also be connected to the conduction line 70 by the side, so as to be electrically connected to the conduction line.

It can be understood that, as shown in FIG. 16, the first electrode traces 30 may also be directly disposed on the surface of the first matrix layer 70 corresponding to the sensing area, and the first electrode traces 30 and the first conductive layer 20 are disposed on the same side. The second electrode traces 50 may also be directly disposed on the surface of the second matrix layer 80 corresponding to the sensing area, and the second electrode traces 50 and the second conductive layer 40 are disposed on the same side.

There is at least one flexible board (not showed in the figures) in the transparent conductive films according to embodiments of the present invention shown in FIG. 13-FIG. 16. When one flexible board is provided, a conduction groove is disposed on the flexible board, the first electrode traces 30 and the second electrode traces 50 are electrically connected to the conduction groove, respectively. When two flexible boards are provided, a conduction groove is disposed on the two flexible boards, respectively. The first electrode traces 30 and the second electrode traces 50 are electrically connected to the two conduction grooves, respectively.

For convenience, the second conductive grooves and the second electrode grooves of the transparent conductive films according to embodiments of the present invention shown in FIG. 7-FIG. 10, are all called groove. Referring to FIG. 3, the bottom of the groove may be of a non-planar structure. The bottom of the groove may be “V”-shaped, “W”-shaped, curved or wavy. The amplitude of the “V”-shaped, “W”-shaped, curved or wavy bottom of the groove is 500 nm˜1 μm. As the bottom of the groove is set to be “V”-shaped, “W”-shaped, curved or wavy, the shrinkage of the conductive material can be reduced in the drying and curing process after the conductive material is filled into the groove. Filing the conductive material into the second conductive groove and the second electrode groove and curing the conductive material to form the second conductive wires and the second electrode traces, can effectively protect the performance of the conductive material and prevent the breakage of the conductive material caused by shrinkage of the conductive material during the baking process. The width of the groove may be 0.2 μm˜5 μm, the height of the groove may be 2 μm˜6 μm, and the height to width ratio is greater than 1.

The grids of the second conductive layer 40 of transparent conductive films according to embodiments of the present invention shown in FIG. 13-FIG. 16, may be regular grids with repeated pattern (FIG. 4) or random grids (FIG. 5). The second conductive layer 40 includes the second conductive wires intercrossing each other. The second conductive layer 40 is formed by curing the conductive material filled into the second conductive groove. The material of the second conductive layer 40 may be a conductive metal, and the conductive metal may be silver or copper.

The second electrode traces 50 of the transparent conductive films according to embodiments of the present invention shown in FIG. 13-FIG. 16 may be grid-shaped or strip-shaped. The grid-shaped second electrode traces 50 include the second conductive lead wires intercrossing each other. Referring to FIG. 4 and FIG. 5, the grids of the second electrode traces 50 may be regular grids with repeated pattern (FIG. 4) or random grids (FIG. 5). The second electrode traces 50 are formed by curing the conductive material filled into the second electrode groove. The material of the second electrode traces 50 may be a conductive metal, and the conductive metal may be silver or copper. For the strip-shaped second electrode traces 50, the minimal width may be 10 μm˜200 μm, and the height may be 5 μm˜20 μm;

The material of the second matrix layer 80 of transparent conductive films according to embodiments of the present invention shown in FIG. 13-FIG. 16 may be UV adhesive, embossed plastic or polycarbonate.

The transparent conductive film 100 may further include a transparent protection layer (not showed in the figures), where the transparent protection layer covers at least a part of the transparent substrate 10, the first conductive layer 20, the second conductive layer 40, the first electrode traces 30, the second electrode traces 50 and the conduction line 60. The material of the transparent protection layer may be UV curable adhesive (UV adhesive), embossed plastic or polycarbonate. The transparent protection layer of the transparent conductive film 100 can effectively prevent the oxidation of the conductive material.

The visible light transmittance of the transparent conductive film 100 described above is not less than 86%.

According to embodiments of the present invention, the touch panel described above includes a transparent conductive film 100; a transparent substrate 10 of the transparent conductive film 100 includes a body 110 and a flexible board 120, and the first conductive layer 20, the second conductive layer 40 and the conduction line 60 are disposed on the same transparent substrate so as to form the conductive film and the flexible circuit board. Therefore, comparing with the conventional method that needs to adhere a conductive film and a flexible circuit board by an adhering process, the production efficiency of the transparent conductive film 100 according to embodiments of the present invention can be improved since an adhering process is not needed. The connection between a flexible connecting component and an external device can be realized via adhering or bonding, or via direct plug-in connecting by providing a male or female end at the end portion of the flexible connecting component. Meanwhile, since the adhering or bonding process is not needed, the production cost can be lowered, and the production yield can be improved. Therefore, the production efficiency and the production yield of the touch panel according to embodiments of the present invention can be improved.

It should be noted that the foregoing embodiments merely describe several implementing modes of the present invention with specific details, and should not be interpreted as limiting the present invention. Persons of ordinary skill in the art may make variants and modifications to the technical solution described in the foregoing embodiments without departing from the conception of the present invention, all of these variants and modifications fall within the protection scope of the present invention. Therefore, the scope of protection of the present invention should subject to the accompanying claims.

What is claimed is:

1. A touch panel, comprising a transparent cover lens, a transparent conductive film and a display apparatus, which are successively stacked; wherein
the transparent conductive film comprises:
a transparent substrate, wherein the transparent substrate comprises a body and a flexible board which is formed by extending from one end of the body, a width of the flexible board is smaller than a width of the body, the body comprises a sensing area and a border area which is located at an edge of the sensing area;
a conduction line, disposed on a side of the flexible transparent substrate;
a first conductive layer, disposed on a side of the sensing area, wherein the first conductive layer comprises first conductive wires intercrossing each other; and
a first electrode trace, disposed on a side of the border area, the first conductive layer and the conduction line are electrically connected via the first electrode trace.

2. The touch panel according to claim 1, wherein:
on a surface of the sensing area, a first conductive groove is disposed, and the first conductive layer is accommodated in the first conductive groove;
the first electrode trace is embedded in a surface of the border area, or is directly disposed on the surface of the border area.

3. The touch panel according to claim 2, wherein:
the transparent conductive film further comprises a second conductive layer and a second electrode trace, and a second conductive groove is disposed on the surface of the sensing area corresponding to the first conductive layer, wherein the second conductive layer is accommodated in the second conductive groove; and
the second electrode trace is embedded in the surface of the border area, or is directly disposed on the surface of the border area, and the second conductive layer and the conduction line are electrically connected via the second electrode trace.

4. The touch panel according to claim 2, wherein:
the transparent conductive film further comprises a matrix layer, a second conductive layer and a second electrode trace, wherein the matrix layer is disposed on a surface of the transparent substrate away from the first conductive layer;
on a surface, which is away from the transparent substrate, of the matrix layer corresponding to the sensing area, a second conductive groove is disposed, and the second conductive layer is accommodated in the second conductive groove;
the second electrode trace is embedded in a surface of the matrix layer corresponding to the sensing area, or is directly disposed on the surface of matrix layer corresponding to the sensing area, and the second conductive layer and the conduction line are electrically connected via the second electrode trace.

5. The touch panel according to claim 2, wherein:
the transparent conductive film further comprises a matrix layer, a second conductive layer and a second electrode trace, wherein the matrix layer is disposed on a surface of the first conductive layer; on a surface, which is away from the transparent substrate, of the matrix layer corresponding to the sensing area, a second conductive groove is disposed, and the second conductive layer is accommodated in the second conductive grove;
the second leading electrode is embedded in a surface of the matrix layer corresponding to the border area, or is directly disposed on the surface of the matrix layer corresponding to the border area, and the second conductive layer and the conduction line are electrically connected via the second electrode trace.

6. The touch panel according to claim 1, wherein:
the transparent conductive film further comprises a first matrix layer disposed on the transparent substrate, and a first conductive groove is disposed on a surface of the first matrix layer away from the transparent substrate, wherein the first conductive layer is accommodated in the first conductive notch;
the first electrode trace is embedded in a surface of the first matrix layer corresponding to the border area, or is directly disposed on the surface of the first matrix layer corresponding to the border area.

7. The touch panel according to claim 6, wherein:
the transparent conductive film further comprises a second matrix layer, a second conductive layer and a second electrode trace, wherein the first matrix layer, the transparent substrate and the second matrix layer are successively stacked; on a surface of the second matrix layer away from the transparent substrate, a second conductive groove is disposed, and the second conductive layer is accommodated in the second conductive groove;
the second electrode trace is embedded in a surface of the second matrix layer corresponding to the sensing area, or is directly disposed on the surface of the second matrix layer corresponding to the sensing area, and the second conductive layer and the conduction line are electrically connected via the second electrode trace.

8. The touch panel according to claim 6, wherein:
the transparent conductive film further comprises a second matrix layer, a second conductive layer and a second electrode trace, wherein, the second matrix layer is disposed on a surface of the first conductive layer, on a surface of the second matrix layer away from the first conductive layer, a second conductive groove is disposed, and the second conductive layer is accommodated in the second conductive groove;
the second electrode is embedded in a surface of the second matrix layer corresponding to the sensing area, or is directly disposed on the surface of the second matrix layer corresponding to the sensing area, and the second conductive layer and the conduction line are electrically connected via the second electrode trace.

9. The transparent conductive film according to claim 3, wherein:
a bottom of the first conductive groove is of a non-planar structure, and a bottom of the second conductive groove is of a non-planar structures.

10. The touch panel according to claim 9, wherein:
a width of the first conductive groove is 0.2 μm˜5 μm, a height of the first conductive groove is 2 μm˜6 μm, and a height to width ratio is greater than 1;
a width of the second conductive groove is 0.2 μm˜5 μm, a height of the second conductive groove is 2 μm˜6 μm, and a height to width ratio is greater than 1.

11. The touch panel according to claim 7, wherein:
a material of the first matrix layer is UV adhesive, embossed plastic or polycarbonate;
a material of the second matrix layer is UV adhesive, embossed plastic or polycarbonate.

12. The touch panel according to claim 3, wherein:
the first electrode trace is grid-shaped or strip-shaped, the grid-shaped first electrode trace comprises first conductive leads intercrossing each other, the strip-shaped first electrode trace has a minimal width of 10 μm˜200 μm and a height of 5 μm˜20 μm;
the second electrode trace is grid-shaped or strip-shaped, the grid-shaped second electrode trace comprises second conductive leads intercrossing each other, the strip-shaped second electrode trace has a minimal width of 10 μm˜200 μm and a height of 5 μm˜20 μm.

13. The touch panel according to claim 1, wherein:
the conduction line is grid-shaped or strip-shaped, the grid-shaped conduction line is formed by intercrossing conduction wires.

14. The touch panel according to claim 1, wherein:
the transparent conductive film further comprises a transparent protection layer, wherein the transparent protection layer covers at least a part of the transparent substrate, the first conductive layer, the second conductive layer, the first electrode traces the second electrode trace and the conduction line.

15. The touch panel as claimed in claim 1, wherein:
a visible light transmittance of the transparent conductive film is not less than 86%.

16. The transparent conductive film according to claim 4, wherein:
a bottom of the first conductive groove is of a non-planar structure, and a bottom of the second conductive groove is of a non-planar structures.

17. The transparent conductive film according to claim 5, wherein:
a bottom of the first conductive groove is of a non-planar structure, and a bottom of the second conductive groove is of a non-planar structures.

18. The transparent conductive film according to claim 7, wherein:
a bottom of the first conductive groove is of a non-planar structure, and a bottom of the second conductive groove is of a non-planar structures.

19. The transparent conductive film according to claim 8, wherein:
a bottom of the first conductive groove is of a non-planar structure, and a bottom of the second conductive groove is of a non-planar structures.

20. The touch panel according to claim 8, wherein:
a material of the first matrix layer is UV adhesive, embossed plastic or polycarbonate;
a material of the second matrix layer is UV adhesive, embossed plastic or polycarbonate.

21. The touch panel according to claim 4, wherein:
the first electrode trace is grid-shaped or strip-shaped, the grid-shaped first electrode trace comprises first conductive leads intercrossing each other, the strip-shaped first electrode trace has a minimal width of 10 μm˜200 μm and a height of 5 μm˜20 μm;
the second electrode trace is grid-shaped or strip-shaped, the grid-shaped second electrode trace comprises second conductive leads intercrossing each other, the strip-shaped second electrode trace has a minimal width of 10 μm˜200 μm and a height of 5 μm˜20 μm.

22. The touch panel according to claim 5, wherein:
the first electrode trace is grid-shaped or strip-shaped, the grid-shaped first electrode trace comprises first conductive leads intercrossing each other, the strip-shaped first electrode trace has a minimal width of 10 μm˜200 μm and a height of 5 μm˜20 μm;
the second electrode trace is grid-shaped or strip-shaped, the grid-shaped second electrode trace comprises second conductive leads intercrossing each other, the strip-shaped second electrode trace has a minimal width of 10 μm˜200 μm and a height of 5 μm˜20 μm.

23. The touch panel according to claim 7, wherein:
the first electrode trace is grid-shaped or strip-shaped, the grid-shaped first electrode trace comprises first conductive leads intercrossing each other, the strip-shaped first electrode trace has a minimal width of 10 μm˜200 μm and a height of 5 μm˜20 μm;
the second electrode trace is grid-shaped or strip-shaped, the grid-shaped second electrode trace comprises second conductive leads intercrossing each other, the strip-shaped second electrode trace has a minimal width of 10 μm˜200 μm and a height of 5 μm˜20 μm.

24. The touch panel according to claim 8, wherein:
the first electrode trace is grid-shaped or strip-shaped, the grid-shaped first electrode trace comprises first conductive leads intercrossing each other, the strip-shaped first electrode trace has a minimal width of 10 μm˜200 μm and a height of 5 μm˜20 μm;
the second electrode trace is grid-shaped or strip-shaped, the grid-shaped second electrode trace comprises second conductive leads intercrossing each other, the strip-shaped second electrode trace has a minimal width of 10 μm˜200 μm and a height of 5 μm˜20 μm.
